(19) United States
(12) Patent Application Publication
(10) Pub. No.: US 2022/0383434 A1
(43) Pub. Date: Dec. 1, 2022

(54) TCS, Tube Conveyor System of a purchase for drive-through pickup.

(71) Applicant: Hashem Sultan, Pembroke Pines, FL (US)

(72) Inventor: Hashem Sultan, Pembroke Pines, FL (US)

(21) Appl. No.: 17/334,991

(22) Filed: May 31, 2021

(51) Int. Cl. G06Q 50/12; G06Q 30/06; G05B 15/02

(52) U.S. Cl. CPC G06Q 50/12; G06Q 30/0635; G05B 15/02; G07C 9/21

(57) ABSTRACT

A system and a method for online order and easy pickup comprising (1) a mobile application capable of interacting with customer to place and pay for the order, set up the time for pickup, generating order number and readable code associated with said order number, (2) a Tube Conveyor System (TCS) connecting the merchant's processing station to a kiosk. (3) said kiosk is located near the merchant facility for drive-through pickup using the order number and its associated readable code.

A system for drive through order and pickup comprising (i) at least one kiosk at a business facility capable of taking customer's order and process payment, (ii) a freely mobile capsule carrying the order, (iii) a Tube conveyor System capable of moving said capsule from the business process station to said kiosk

### FIELD OF THE INVENTION

The present disclosure relates to tube transportation system to a kiosk for customer's drive-through pickup of online or direct order at the kiosk. The invention related mostly to fast food industry providing efficient new method of delivering food order to drive-through customers.

### BACKGROUND OF THE INVENTION

Online order has become a very popular method of ordering food, grocery, medicine, books, electronics and almost any type of goods. Online purchases are usually delivered by a carrier. Foods, for example are usually delivered by a third-party carrier such as Uber Eat, or by personnel contracted with the business. Delivery services usually is costly by adding extra fees for the delivery and additional tips to the deliverer.

Customers may pick up their order by stopping at the restaurant facility or drive through pick up from the window of the restaurant. In almost every case, picking up the online order necessitate queueing behind long line customers coming to place their order at the spot. This usually eliminates the advantage of online orders, since customers could have simply placed their order on the spot with almost equal time of waiting. Some fast food uses a separate lane for online order. However, the applied method is usually slow and ineffective. The customer has to wait for a business employee to bring the order personally to the customers, or customers have to step down to a pickup location.

In an attempt to solve this problem, Kelly et al in his U.S. Pat. No. 10,304,147 B2, dated Apr. 28, 2019 disclosed a solution to the problem by disclosing a dispenser, wherein the dispenser includes a plurality of bins configurated for storage of food items, to dispense one or more food items to users presenting the mobile device with the encoded barcode. The dispenser is located at a pickup location disconnected from the restaurant. His dispenser is located interior or exterior to the fast-food restaurant with access ports in the rear for employee access to place prepared food in a bin. The invention disclosed a method of placing and make a payment of an order online or at the service counter or at a kiosk within the store or a kiosk located on a drive-through lane. After interaction with the kiosk or the service counter the customer is directed to the food dispenser.

Kelly's invention lacks the most important element of easy and practical method for how the food is transported from the processing area to the dispenser, it also requires customers to stop at another location to pick up the order.

Kelley's invention did not describe any automatic method of transporting food to the dispenser. Instead, he described a method for manual placing the food in the corresponding bins from an access at the back of the dispenser, in a similar way P.O Boxes receive the mail.

Johnson in his patent publication No. US 2006/0218039 A1, dated Sep. 28, 2006, describes a method of operating a fast-food restaurant, the restaurant having an order and staging stations for drive through customers. The order and staging stations have a plurality of order stalls having an order panel and payment acceptor. The customer vehicle remains in the order stall until the customer is notified that the order is ready for pickup at the delivery station.

Havas, in his U.S. Pat. No. 9,406,084 B2 dated Aug. 2, 2016 described a method for submitting a food order remotely. The invention does not disclose any information on how the order is delivered to the pickup location and how the ordered is picked up.

Napper, in his U.S. Pat. No. 10,546,343 B2 dated Jan. 28, 2020, described a method for fulfilling a plurality of orders for goods at a provider location comprises obtaining an arrival sequences estimate for each of a plurality of users indicating the sequence in which the users are expected to arrive and organizing completed order s according to the arrival sequence estimate. Nappers invention does not describe any additional information on how the order is picked up or on how the prepared order is transported from the processing location to the pickup location.

Chinese patent No. CN 206480096U granted on Sep. 8, 2017 describes what is called a novel intelligent fast food takes out pickup storage cabinet for customers' pick up online order. The cabinets are arranged in vertical and horizontal arrangement heating system and microprocessor and barcode scanning equipment.

Chinese patent No. CN 102057116B, granted on Dec. 25, 2013, described a drive through system and method for food business comprising a drive-through ordering and delivering system. The building of the business has a primary food delivery window for passing ready orders to drive-through customers, and a downstream in-line parking area for area for drive-through vehicles having a delayed order. When the delayed order is ready for delivery, an attendant can deliver the ready order via an approximate doorway to the vehicle.

Wolfe et al in his patent No. U.S. Pat. No. 9,821,965 B2 dated Nov. 21, 2017, described a system and method for tracking/controlling access to transported articles via sharing online information between the sending and the receiving stations related to item ID, carrier ID and the user ID to enable the authorized person to open the lock of the container of the article. The container is designed for delivery via a pneumatic tube delivery system.

Bambrogan et al in his U.S. Pat. No. 10,093,493 B2, dated Oct. 9, 2018, describes a method for manufacturing a transportation tube for high-speed transportation for passengers.

Cothern in his patent No. U.S. Pat. No. 9,599,235 B2 dated Mar. 21,2017 described a high-speed travel system comprising at least one transportation tube and at least one track and at least one capsule configurated for travel through the tube between two stations, a propulsion system, a levitation system and a gate valve.

Oster, in his patent No. U.S. Pat. No. 9,228,298 B2 dated Jan. 5, 2016 described an evacuated tube transportation system with interchanging capability using High Temperature Superconductor maglev for Evacuated Tube Transfer (ETT) with a magnetic levitation structure for ETT capsule vehicle traveling in an evacuated tube.

Zhou in his patent No. U.S. Pat. No. 8,915,192 B2 dated Dec. 23, 2014 describes a circulated pneumatic tube transit system to transfer passenger/cargo along a pair of pneumatic tubes, which are positioned along each other.

Greyshock in his U.S. Pat. No. 10,315,851 B2 dated Jun. 11, 2019 described a system and a method of medication distribution within a healthcare facility. Pneumatic tube conveyor system is widely used in health facilities to send and receive medication to a pharmacy, human tissues such as biopsy, blood, urine to the laboratory. Banks are widely using the Pneumatic tube conveyor to send and receive checks, money and other documents.

The pneumatic tube conveyor is not suitable for food industry and suitable for conveying large items. Though, the system can be upscaled in size to accommodate large items

### SUMMARY OF THE INVENTION

The current invention discloses a new methods and system combining current technology in a unique system that makes drive-through pickup of online order more convenient to the customer and more efficient to the business, eliminating wasting time for both parties.

The current invention provides several advantages to the customer by providing easy convenient online order and drive-through pickup, less or no waiting time, less costs by eliminating the need for third party deliverer.

Another objective of this invention is to provide businesses with reducing labor cost, increasing profit, increased efficiency and productivity,

The new invention comprises (1) business application allowing customers to purchase and pay online and generate readable code with the order number, (2) Kiosk(s) for picking up the purchase having a locked door that can be opened by entering the order number and its associated code into the Kiosk screen, (3) a Tube Conveyor System (TCS) conveying the purchased material from the processing location to Kiosk.

The current disclosure describes the fast food and restaurant takeaway as an example. However, the same description is applied to other purchases such as electronics, books, grocery, medications at busy businesses such as Best Buy, Barnes and Noble, Kroger and other Grocery stores, Home Depot and any other busy businesses.

Several forms of the TCS are described using: (i) a system using mechanical energy, (ii) a system using a mobile electromagnet using mechanical and electromagnetic energy, (iii) a system using stationary electromagnetic energy, (iv) a system using pneumatic energy. Each of these systems can be located above the ground, under the ground or a combination of both above and under the ground.

(1) The business application, in the preferred embodiment, allows customers to choose a specific store convenient for drive-through pickup based on customer's location and zip code, to choose his purchase from a menu of options, to select a preferred time for pickup, make online payment, issue an order number and readable code, sending the customer the exact location for the pickup, a kiosk number, immediately prior to the agreeable time of the pickup.

(2) Pickup kiosk(s) is located near the merchant facility for drive-through pickup using order number and its associated readable code. The kiosk, in the preferred embodiment comprises interactive digital screen capable of reading the code and/or entering digits of the order number and the digital code, speaker, help button, optional payment processor, a cabinet holding the pickup articles, a locked door that can be opened by entering/scanning the code or remotely by the business employee.

(3) Tube conveyor system (TCS) connecting the order processing station to a specific kiosk conveying a specific order. The TCS, in the preferred embodiment, can be above the ground, under the ground or a above the ground in part and below the ground in part. The order is placed in a specific capsule compatible with the design of the system.

TCS, may use mechanical, mobile electromagnet, stationary electromagnet, or pneumatic energy.

(i) In the first preferred embodiment, electromagnet (EM) having an axis connected to a motorized cable is used. When the EM is turned on, it picks up the compatible capsule and drive it along its track to a location just above the vertical portion of the TCS above the Kiosk. When EM is turned off, the capsule will fall down along its track into the kiosk. A reverse process occurs for picking up the capsule and convey it back to the sender. The capsule track ensure that the door of the capsule is always facing the sender and the receiver.

(ii) in the second preferred embodiment, a motorized cable is configurated to pull the capsule from its bottom by a 360-degree freely mobile L-shaped bar connecting the motorized cable to the capsule. The 360-degree mobility of the L-shape bar allows the capsule to move along its track so that the window of the capsule always faces the sender and the receiver.

(iii) the disclosure describes a third form of TCS using multiple electromagnets configurated to work in an on and off harmony to transport the capsule to its destination along a track capsule. The capsule track ensure that the door of the capsule is always facing the sender and the receiver.

(iv) the disclosure describes a fourth form of TCS using pneumatic energy. The capsule in this form of system is usually small and useful for small size items such as medications. Yet, it can be scaled up to be compatible with large items.

Other objectives, aspects, purposes of the presently described system and method can be obtained from a study of the specification, the drawings, and the appended claims.

### BRIEF DESCRIPTION OF THE DRAWING

FIG. 1 is a schematic view of the pickup kiosks at the business facility showing three different types of pickup services.

FIG. 2 is a schematic view of a different setup of the pickup kiosks at the business facility.

FIG. 3 is a schematic view of the process of placing online order.

FIG. 4 is a schematic view of the process of picking up order for customer agreed on exact pickup time.

FIG. 5 is a schematic view of the process of picking up order for customer opted to come for pickup on their convenience, no setup time for pickup.

FIG. 6A is a schematic view of the kiosk.

FIG. 6B is a schematic view of the kiosk door and the capsule door are opened for picking food and drink.

FIG. 7A is a schematic view of a capsule configurated to be compatible with the motorized cable version of the TCS described in FIG. 12.

FIG. 7B is a schematic view of coronal plane section of a capsule.

FIG. 7C is a schematic view of the capsule wheels' configuration.

FIG. 7D is a schematic view of a capsule configurated to be compatible with electromagnet version of the TCS.

FIG. 8A is a schematic view of the capsule moving on its track for the motorized cable version of the TCS described in FIG. 12 and FIG. 13A, B.

FIG. 8B is a schematic view of a capsule moving on its track configurated to be compatible with electromagnet version of the TCS described in FIG. 10 & FIG.14

FIG. 9 is a schematic draw of the TCS at the sender's station

FIG. 10 is a schematic view of the TCS using a mobile electromagnet.

FIG. 11 is a detailed description of the mobile magnet moving on its tract.

FIG. 12 is a schematic view of the TCS using motorized cable.

FIG. 13A and FIG. 13B are an illustration of the L-shaped mover of the capsule in the motorized cable version of the TCS.

FIG. 14 is a schematic view of TCS using stationary electromagnets.

FIG. 15A is a schematic view of TCS using pneumatic energy.

FIG. 15B is a schematic illustration of the capsule compatible with the TCS using pneumatic energy.

FIG. 16 is a schematic illustration of TCS system underground in part and above ground in part.

### DETAILED DESCRIPTION OF THE PREFERRED EMBODIMENTS OF THE INVENTION

The current invention discloses a new methods and system combining current technology in a unique system that makes drive-through pickup of online order more convenient to the customer and more efficient to the business, eliminating wasting time for both parties. The current invention provides several advantages to the customer by providing easy convenient online order and drive-through pickup, less or no waiting time, less costs by eliminating the need for third party deliverer.

Another objective of this invention is to provide businesses with reducing labor cost, increasing profit, increased efficiency and productivity,

The new invention comprises (1) business application allowing customers to purchase and pay online and generate readable code with the order number, (2) Kiosk(s) for picking up the purchase having a locked door that can be opened by entering the order number and its associated code into the Kiosk screen, (3) a Tube Conveyor System (TCS) conveying the purchased material from the processing station to Kiosk.

The current disclosure describes the fast food and restaurant takeaway as an example. However, the same description is applied to other purchases such as electronics, books, grocery, medications at busy businesses such as Best Buy, Barnes and Noble, Kroger and other Grocery stores, Home Depot and any other busy businesses.

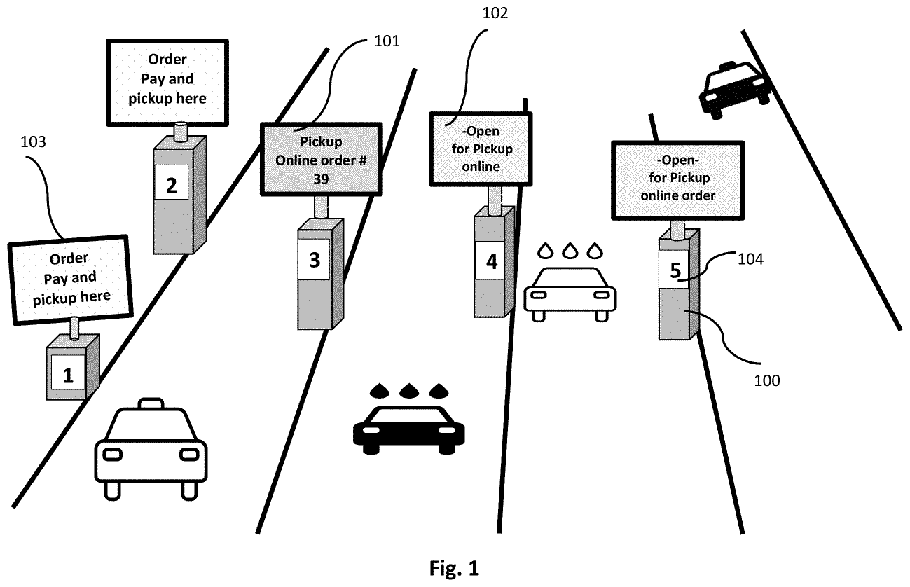

FIG. 1 illustrate the preferred set up of the kiosks 100 on different drive-through lanes. The number of the kiosks could be one to several depending on the types of business and its needs. Kiosks are assigned clear identifying sequential number 104. In the preferred embodiment, each kiosk may be assigned specific function.

For example, kiosk #3 is assigned for picking up specific online order at a specific time. The display screen 101 of this kiosk will display the order number. The customer will be notified couple of minutes earlier on his mobile device about the number of the kiosk for his pickup.

Furthermore, other kiosk(s) such as No. 4 and 5 are assigned for picking up online orders for convenience pickup time. The screen 102 displays its information that any online order can be picked up here. Other kiosk, such as No. 1 and 2, display their assignment 103 that any customer may place order at this kiosk, pay on the kiosk and receive their order directly to the same kiosk or to a different kiosk for picking up their order. Customer may be asked to move forward to the next kiosk, No. 2 for example, for the pickup. The facility may assign a different kiosk for pickup order so that Kiosk No. 1 can serve the next customer waiting in the queue.

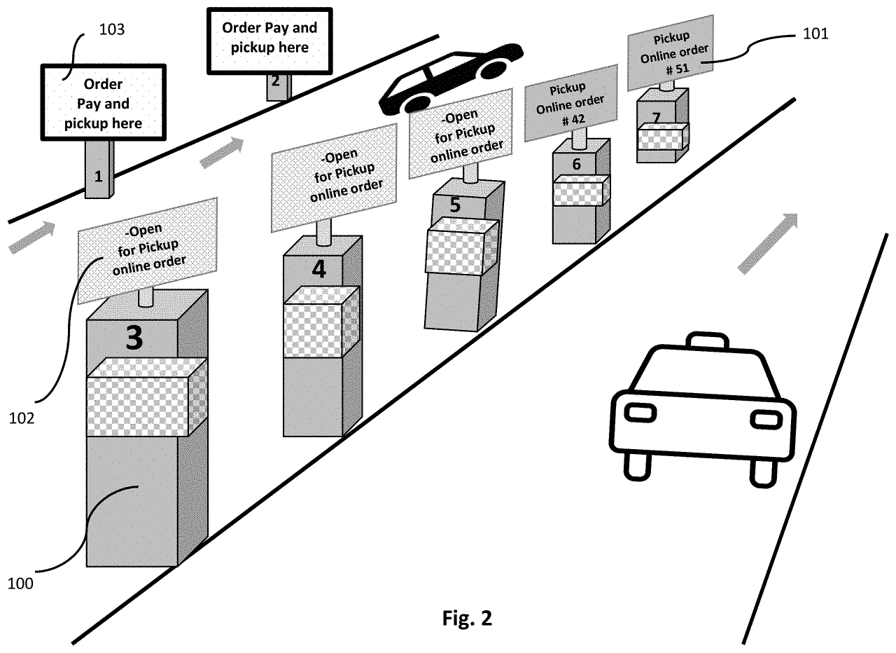

FIG. 2 illustrate a different setup for drive-through pickup. One lane for online order customers, and a second lane for on-spot order, pay and pickup. The business may have additional traditional lane for window services.

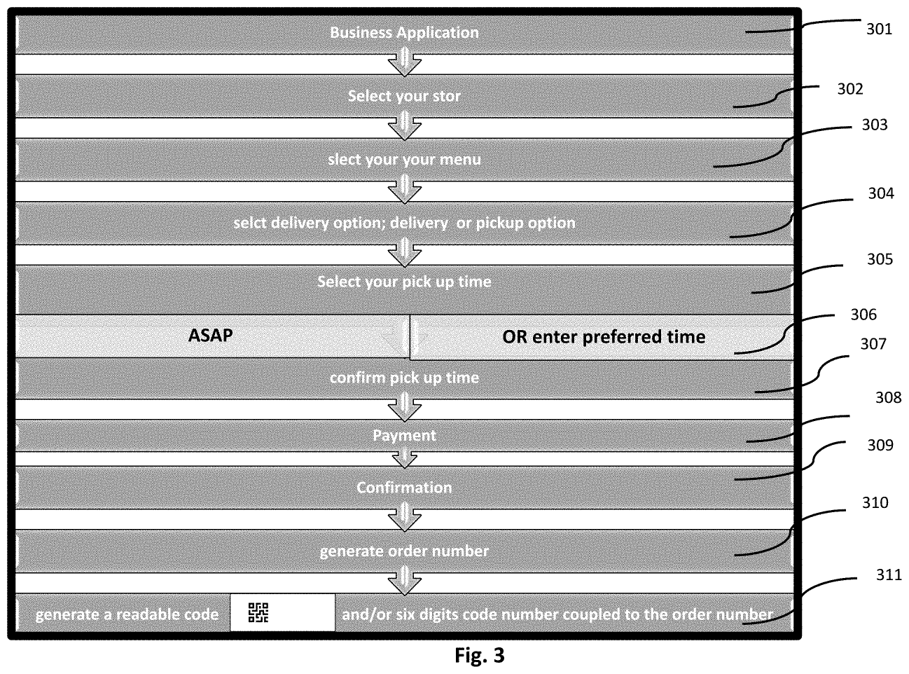

FIG. 3 illustrate the process of online order and time-specific pickup. It is very customary that businesses have their own business application and/or a website 301. Adding some changes to the application is well known in the arts and can be modified easily. Most of busy businesses have several locations and usually the same menu. Customer are asked to select their store 302, then is asked to make his selection from a menu or a list of the products 303.

Next, select delivery options 304. Customer may choose between delivery option and pickup option. The next steps are applied to pick-up options only. Customer is then asked to select time to have order ready for pickup 305. Customer may select ASAP option 306. In response to this ASAP selection the business set up the most available time for pickup. If, on the other hand, the customer selected his preferred time 306, the application will ask him to enter the preferred time. If the selected time is within the capability of the business to have the order ready at the requested time, it will confirm the appointment 307. If the requested time was too early and beyond the ability to have the order prepared, the application will respond “please enter a preferred time after this time xx:yy”.

After time is confirmed, the customer is asked to make his payment online 308, using any type of known online payments such as credit card, PayPal. After payment is confirmed 309, the application generates order number 310 and numerical and/or readable code 311 such as QR code or a bar code or any other codes available in the market.

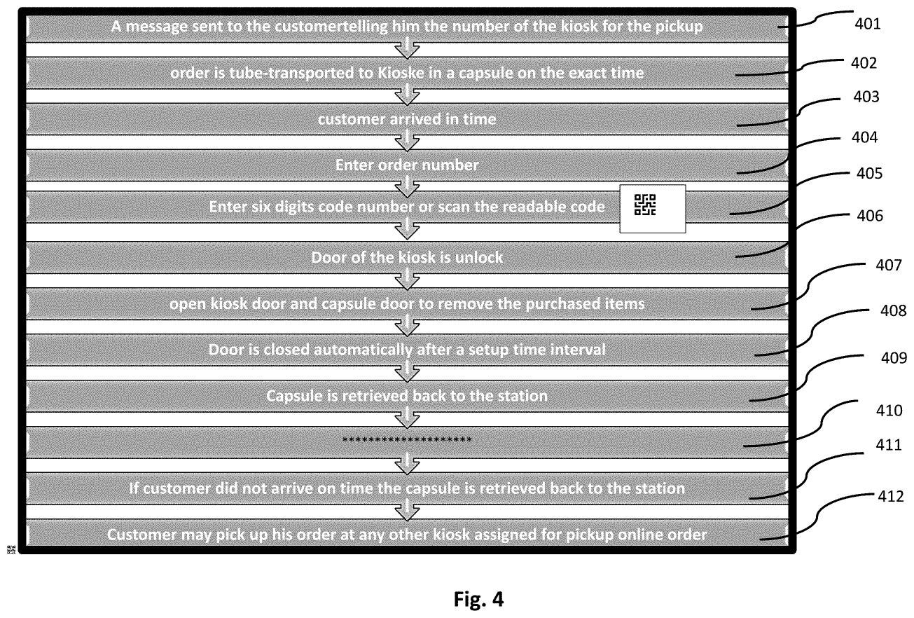

FIG. 4 illustrates the process of picking up an order after agreeing on a specific time for the pickup. Few minutes prior the pickup set time, the customer receives a notification 401 that his pickup location is at a specific kiosk, giving the customer the kiosk number. The order is then conveyed to the same Kiosk in a capsule on the exact time 402, the Kiosk display the order number on its screen 101.

When the customer arrives at the specific time, he enters his order number and the associated code the digital code 603 or scan the readable code 602. The kiosk door 601 is unlooked. If for any reason the door does not open, the customer may press the help button 605 and speak to the employer via the speaker 604. The employer will verify the order number and the digital code and then remotely opens the door. The kiosk's door is closed automatically after a set up period, and the capsule is retrieved back to the sender 409.

If the customer did not arrive at the specific time, the capsule with the food order is retrieved back to the sending station. The food order will be saved in a proper location until the customer comes. Customer may pick up his order at any other open kiosk assigned for pickup online order 102.

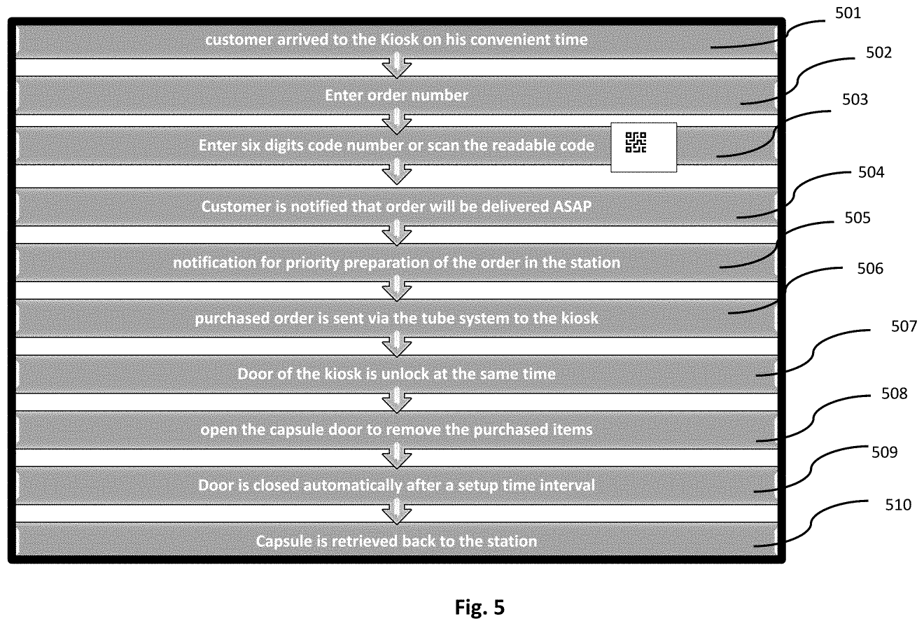

FIG. 5 illustrates the process of picking upline order when no specific time is set for the pickup or when a customer requested a specific pickup time, but he was unable to arrive in time. When the customer arrives on his convenience, he proceeds to any open kiosk assigned for picking online order 102. The customer enters his online order and the associated code at the kiosk. The employee will give online customers priority and will have the order ready ASAP. The customer will be given the approximate time for the food readiness and will be told to stay at the same kiosk or move to a different kiosk. The kiosk's door will be opened automatically when the capsule arrives to the kiosk. After the customer removes his order, the kiosk's door will automatically get closed and locked, and the capsule is retrieved back to the sender.

Furthermore, FIG. 1 and FIG. 2 illustrate a third type of kiosk 103 for placing order on the spot at the kiosk via ordinary method via a speaker, pay for the order at the kiosk and have the purchase tubed to the kiosk. The kiosk's door will open automatically once the order arrives to the kiosk.

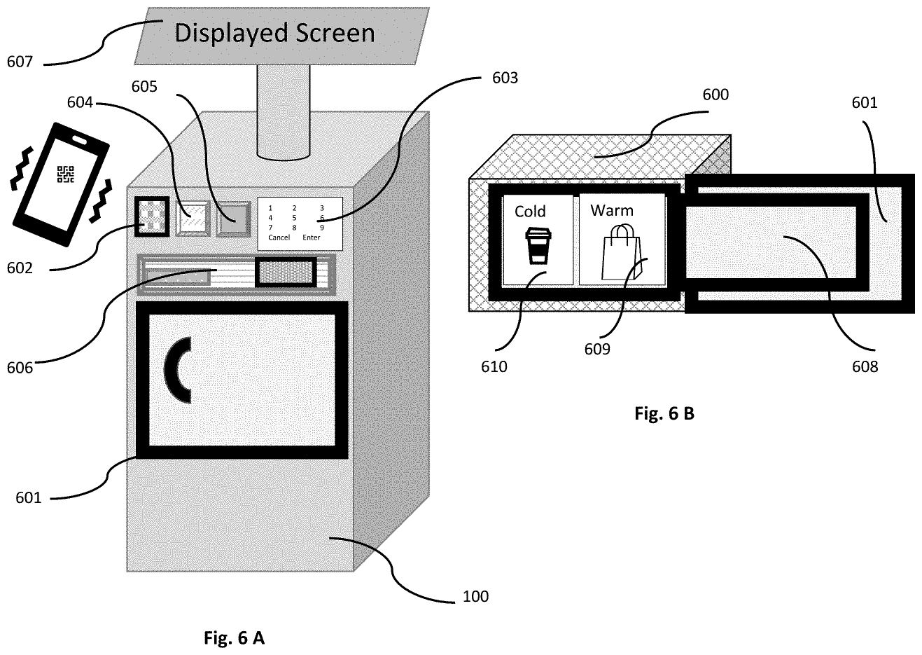

FIG. 6A illustrates a kiosk 100. It comprises a compartment having a locked door 601 big enough to accommodate the capsule 600 which contains the food order. The door 601 is always locked and can be opened remotely by the sending station or by entering the correct order number and the associated code into the system when the food is already in the kiosk. The door is automatically closed when the food is removed after preset time interval and may be locked by the customer after he picks up his order. The system may ask the customer to close the door vis an automatic announcement through the speaker 604.

Kiosk 100 also include an interactive screen 603 allows the customer to enter his order number and the associated code. The code reader may be incorporated within the interactive screen 603 or may be placed separately 602 on the kiosk. The screen may incorporate a payment processing element or may have it placed separately 606 on the kiosk.

The payment element is not required for kiosk assigned for online order pickup.

The kiosk 100 also include a help button 605 to allow customer to call the employee for help and speak to each other via a speaker element 604 to solve any potential problem such as the order missing something, or it was the wrong order. The order can be corrected by retrieving the capsule and send back the missing parts or the correct order.

The kiosk 100 include a large display screen 607 on its top to show the current assignment of the kiosk.

FIG. 6B illustrates the front view of the opened capsule 600. The capsule door 608 is usually closed but not locked. The door is unlocked and can be opened easily once the kiosk door 601 is opened. The figure illustrates the separate components for the hot food 609 and the for the cold drinks 610.

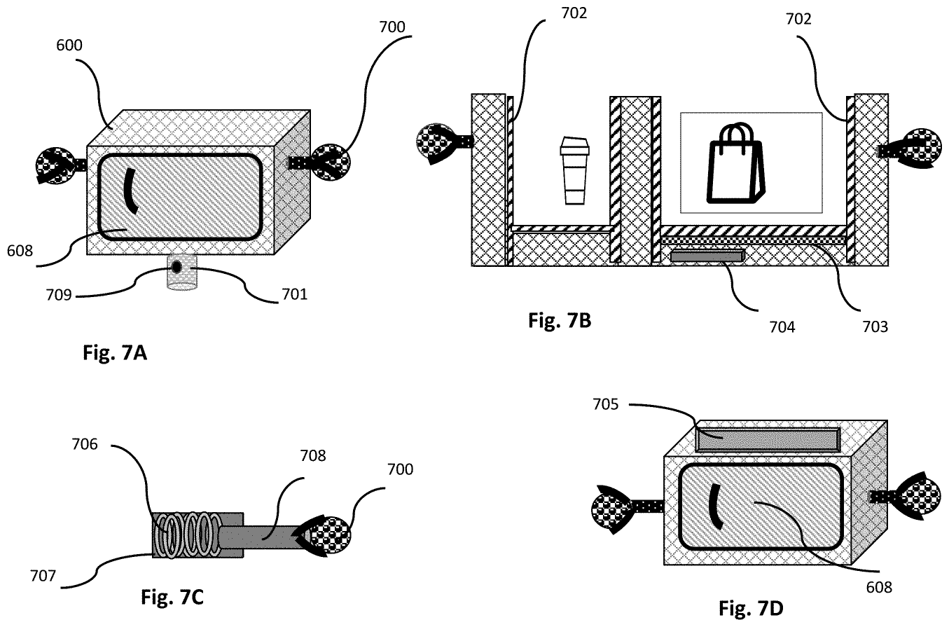

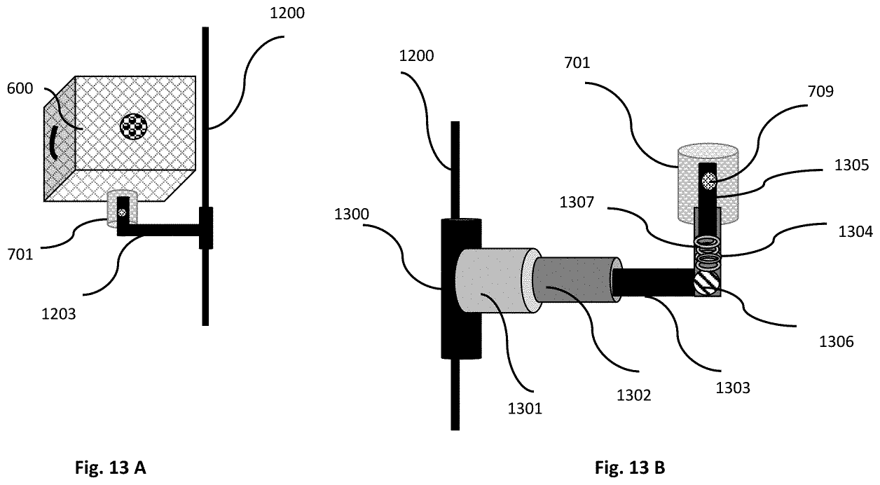

FIG. 7A describe a capsule configurated to be compatible with TCS using motorized cable. The capsule has in the center of its bottom a small hard hollow cylinder 701 configurated to accept the distal solid cylindrical part of an L-shaped element 1305. Part 701 has two click buttons 709 on its wall to match two holes located on the distal part of L-shaped bar 1305. The L-shaped element is fully illustrated in FIG. 13.

FIG. 7 C describes the elements of a 360-degree mobile wheels system attached to the side walls of the capsule comprising of at least two free mobile wheels connected to expandable solid Cylindrical portion 708. The expandable potion is incorporated in another proximal cylinder 707 containing a compressible/expandable spring 706. The spring tends to always expand resulting in constant pressure on the distal part 708 which results in keeping the wheel constantly on its track 800. The proximal portion 707 is incorporated into the side walls of the capsule 600.

FIG. 7 D is an illustration of a capsule configurated to be compatible with electromagnet version of the TCS. It is identical to the capsule described in FIG. 7A, FIG. 7C and fig. B. The only differences are (1) the addition of metal parts 705 compatible to magnet such as iron or steel, and (2) the absence of the element 701 from its bottom.

FIG. 7B is a coronal section of a capsule 600. In food industry, the inside of the capsule us divided into two compartments one compartment for hot food, and one compartment for cold drinks and other cold orders such as Ice cream.

The inside is lined by insulative layer 702 to preserve the inside temperature. In the hot compartment a heating element 703 may be added, such as heating coils. A rechargeable battery 704 may be incorporated inside the wall of the capsule to provide the heating energy for the warm compartment to compensate for the heat loss.

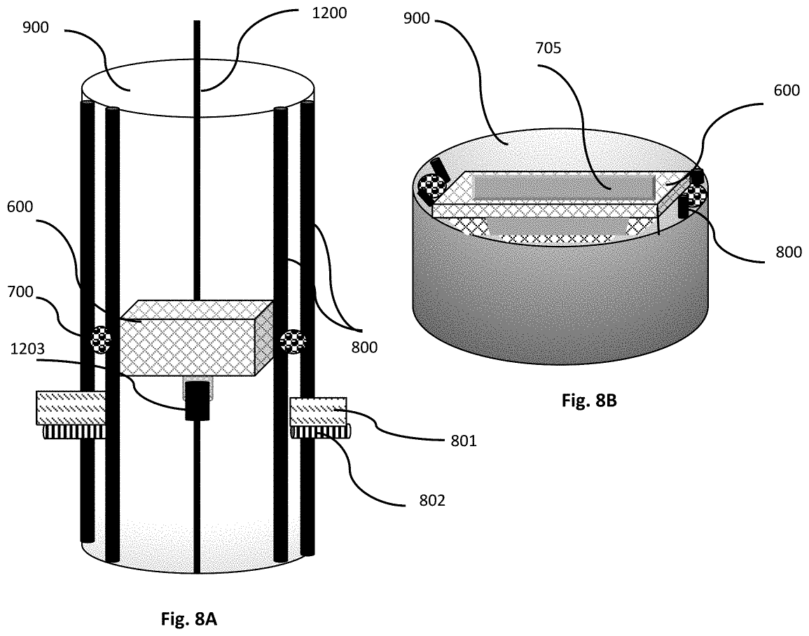

FIG. 8A is an illustration of part of the TCS tube 900 used in the motorized cable version of the TCS. Inside the tube is the track 800 on which the wheels 700 of the capsule 600 move. At the end of the journey at the sending and receiving ends are stoppers 802 padded by shock absorber element 801. Part 802 is a small bar made of any simple material positioned inside the track 800. The shock absorber 801 can be made by air-filled element, compressible spring, or any other compressible structure.

Inside the tube 900 is shown the motorized cable 1005 of the motorized cable system. The capsule is attached to the cable 1005 by an L-shaped connecting body 1203.

FIG. 8B illustrate a top view of part of the electromagnet CTS 900. The capsule 600 having on one or more of its remaining sides (top, bottom, and backside) metal segment 705 compatible with magnet, such as steel or iron. Inside the tube are tracks 800 for the wheels of the capsule.

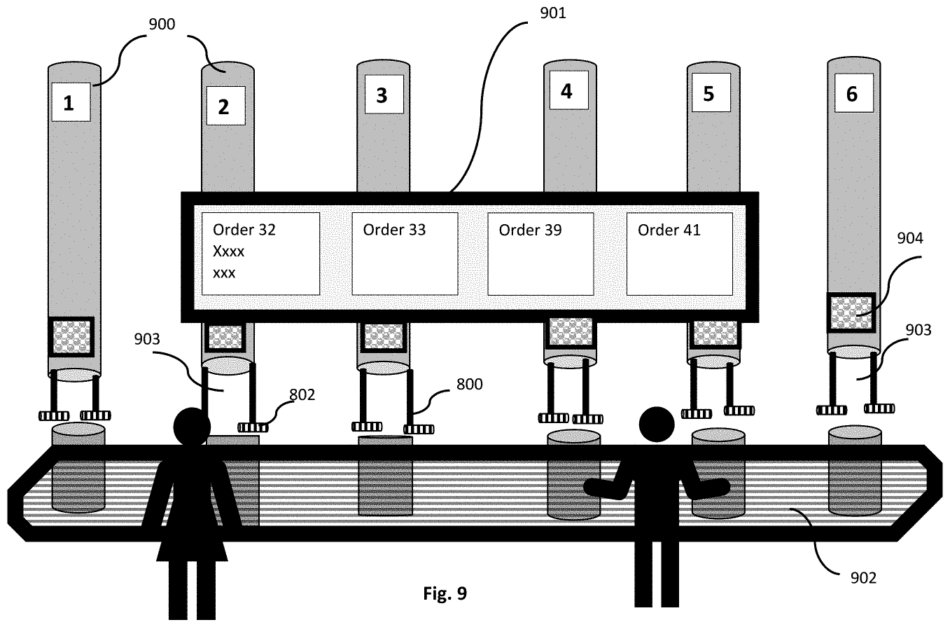

FIG. 9 illustrates the order processing station. A processing desk 902 is where the order is prepared to be send to its kiosk destination. A large screen 901 showing the orders number and the list of the purchases in that order for example, two big mac, two French fries, one crispy chicken sandwich, and two cokes.

The employee verifies the order and load it in the appropriate tube 900. Each tube is assigned a number correlated with a kiosk number 104.

At the level of the processing desk 902, each tube 900 has a large window 903 to load through it the food order in the capsule. Furthermore, the employee may replace the capsule through the same window 903 by another capsule when needed. Removal of the capsule from its tract is done by removing the stopper bar 802 from the track.

Each tube has a speaker and control panel and speaker 904 connected to the speaker of the corresponding kiosk 604. The control panel allows the employee to send and to retrieve the capsule, opening the kiosk's door, change the displayed message on the Kiosk's screen 607, and prioritize customers' orders.

Online orders are prioritized with the online order confirmed pickup time, followed by any online order , then followed by on spot orders.

The process will be more efficient if two persons or teams are working on separate assignments: one for the online order and one for the drive-through order at the facility.

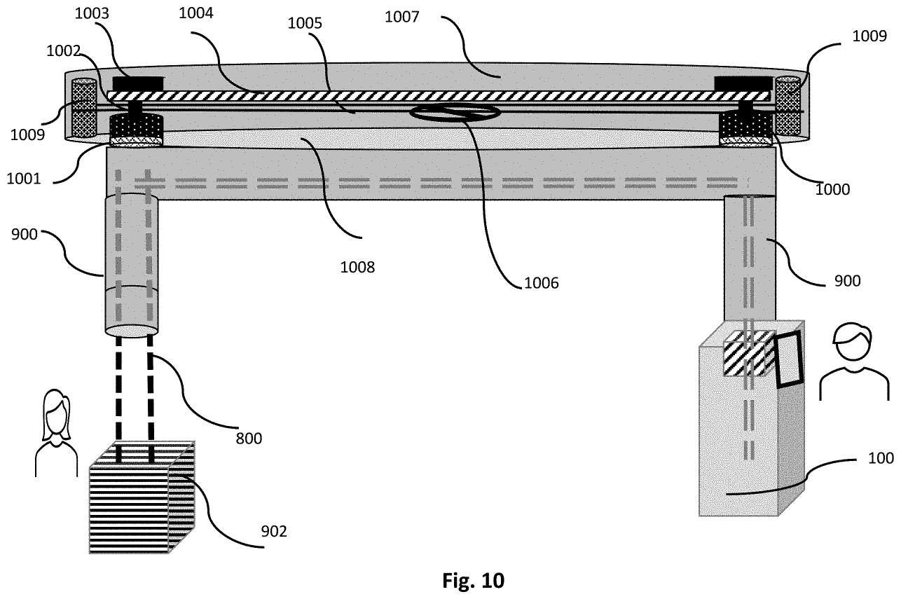

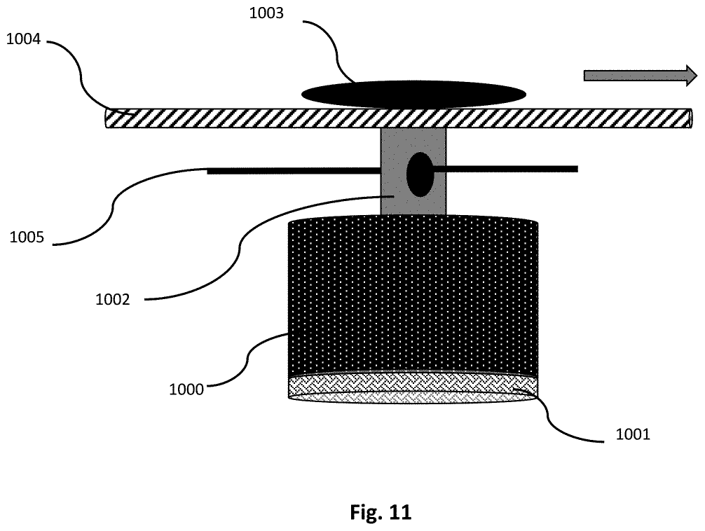

FIG. 10 and FIG. 11 illustrates the Tube Conveyor System (TCS) using mechano-electromagnetic energy. The system comprises at least one electromagnet (EM) 1000 covered at the proximal end by shock absorber element 1001. The EM incorporate in its other end an axis 1002. This axis has larger distal end 1003 allowing the EM to hang and move on a track 1004.

Below the track is a motorized cable 1005. The cable pass through the axis 1002. The point of the connection between the cable and the axis is fixed and move with cable movement.

The axis 1002, the cable 1005, the track 1004 and the large distal end of the axis 1003 are located in a compartment 1007 above the TCS tube 900 and having a wide opening 1008 communicating with the roof of the horizontal portion of the TCS 900. This wide opening allows the electromagnet at the ceiling of the tube 900 to carry the capsule from one end of the horizontal tube to the other end.

The EM is moved from one end of the tube to the other end by a motor 1006. The motor may be placed in the compartment 1007 or outside the tube system. The motor pulls the cable from one corner of the tube to the other corner of the tube and vice versa.

The cable holding the EM does not make a circular movement. The cable moves around pulley 1009 located lateral to the corners of the horizontal part of the TCS and preferably located inside the compartment 1007.

After loading the order in the capsule, the EM is turned on pulling the capsule from the sending point vertically towards the EM located above the corner of the horizontal tube. When the capsule is pulled up it move up on its track 800.

Once the capsule is attached to the magnet, the motor 1006 turns on and move the magnet with the capsule to the other end of the horizontal tube. At this point the motor is turned off followed shortly by EM turning off. The capsule at this corner, after the magnet is turned off, will fall by the force of gravity via the track 800 to its destination, The kiosk.

The capsule will be retrieved in the same manner in the other direction to its home in the sending station.

Since the door of the capsule at the sender facing the employee, and since the door of the capsule must face the customer at the Kiosk, one of the ascending or descending track must follow a twisted path to twist the capsule to have its door facing the customer and the employee when arrive to its destination.

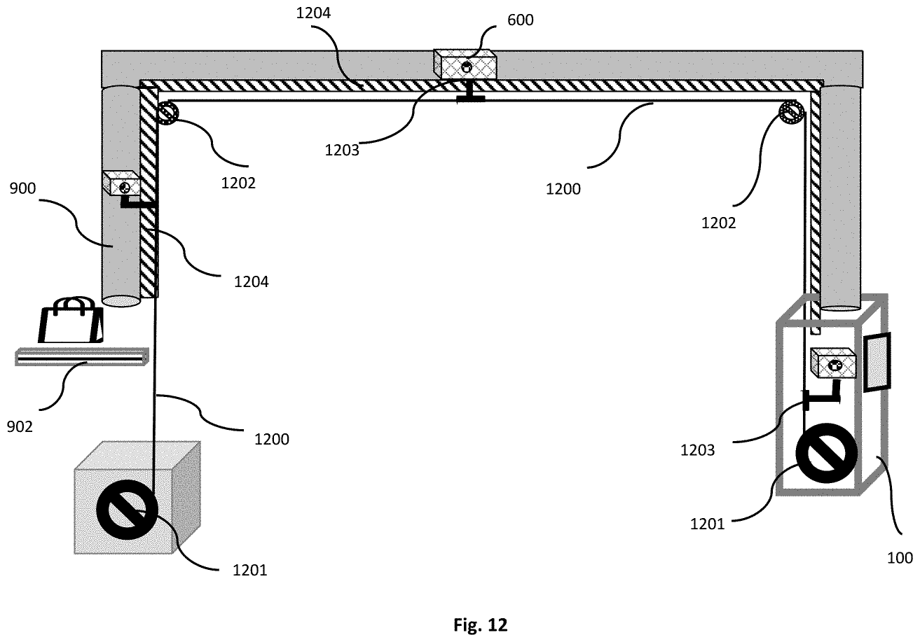

FIG. 12 and FIG. 13 illustrate another preferred embodiment for TCS using mechanical energy produced by at least one motor 1201.

In the preferred embodiments shown in this illustration, two motors are illustrated one at the sender station and the second one below the corresponding kiosk. Each motor has a reel, not shown, connect to the motor to pull or release a heavy-duty cable 1200.

The cable pass above two other pulleys 1202 located at the corners of the TCS below and alongside the tube system. The cable has a heavy duty malleable short segment 1300 configurated to hold an L-shape element 1203.

Said L-shape segment enter the space of the TCS via a long slit 1204 along its whole path. The slit 1204, at any point, lies in a line parallel to a line perpendicular to a line connecting the two wheels at its midpoint.

For clarification, the cable 1200 was shown as if open to the outside. However, in the preferred embodiment, the cable may be enclosed in another tube system parallel to the TCS and both are connected via a common slit 1204.

The L-shape element 1203 comprises several parts necessary to provide free mobility and ability to change directions with the changing the directions of the track 800. This is very necessary since the door of the capsule at the sender facing the employee, and since the door of the capsule must face the customer at the Kiosk, one of the ascending or descending track must follow a twisted path to twist the capsule to have its door facing the customer and the employee when arrive to its destination.

To achieve the free mobility of the capsule, the L-shape element 1203 comprises several segments. In the preferred embodiment described in FIG. 13B the horizontal part comprises telescopic components 1301, 1302, 1303. This allows the capsule to change its direction freely without pulling on the cable. The proximal portion 1301 is firmly incorporated with the segment 1300 described above. The distal end 1303 articulates with the other arm 1304 by a 360-degree mobile joint 1306. Part 1304 contains a compressible spring 1307. The spring allows the part 1305 to syncopate or to expand as the track of the capsule changes.

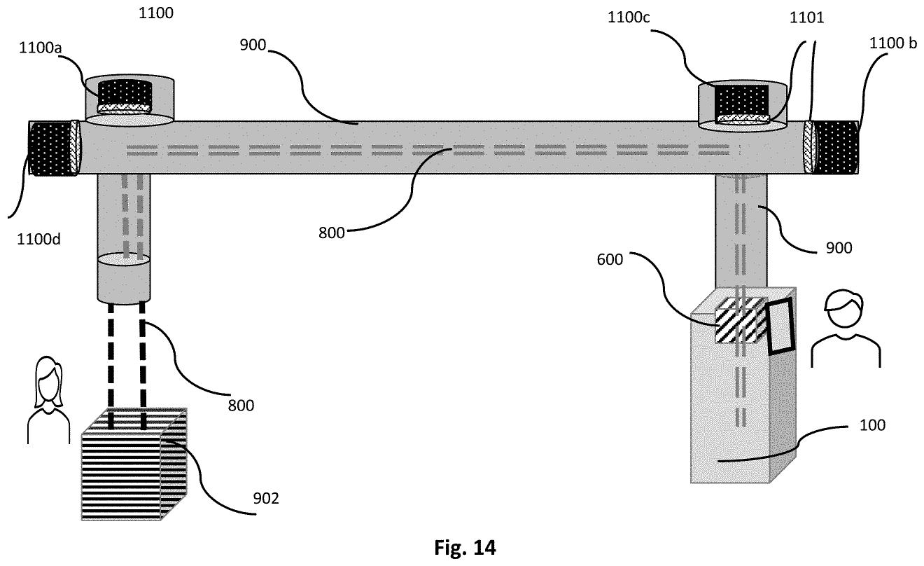

FIG. 14 is an illustration of another assembly of the TCS comprising multiple electromagnets (EM) 1100 positioned individually at locations inside the tube.

In the preferred embodiment, two EMs are positioned at each corner of the TCS. One at each upper end of the vertical sections of the TCS, and one at each end of the horizontal section of the TCS.

EMs are turned on and off sequentially to achieve the conveying of the capsule 600 along its track 800. The process of sending the capsule starts with a push of a button on the control panel 904, which activates the electrical cycle. EM 1100a is turned on pulling the capsule along its tract 800 to the proximal corner of the TCS. At the very time EM 1100a is turned off, the second EM 1100b is turned on moving the capsule to the other corner of the TCS. Once the capsule attaches to said magnet, the EM is turned off allowing the capsule to fall by the force of gravity to its destination.

since the door of the capsule must face the customer at the Kiosk, one of the ascending or descending track must follow a path to twist the capsule to have its door facing the customer and the employee when arrive to its destination.

To retrieve the capsule, the employee will push the receive button on his control panel 904. The process starts with turning on EM 1100c followed by EM 1100d. The capsule is then is allowed to fall to its destination by the force of gravity.

Each of the EM is covered with shock absorber part 1101to reduce the impact of the collision of the capsule with the magnet.

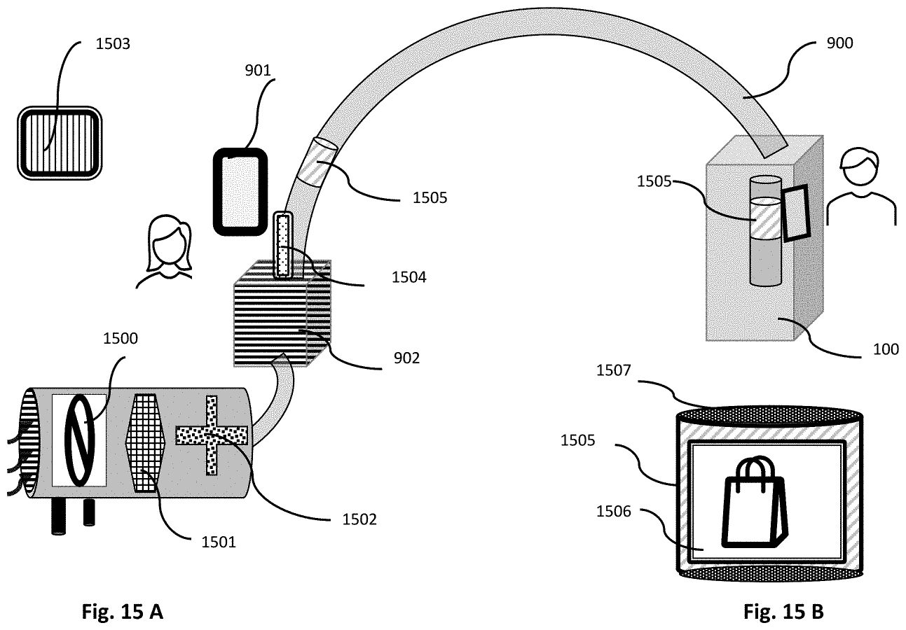

FIG. 15A and B describes another version of the TCS using pneumatic energy. The system, well known to the people in the art, comprises air compressor 1500, a Filter-regulator-Lubricator (FRL) component 1501, and a directional control valve 1502, an electric and pressure control panel 1503.

The capsule 1505 is configurated to move freely inside the tube. The capsule slide inside the tube freely by having low-friction wall and low friction cap 1507. A door 1506 allows the employee to place the order inside the capsule. The employee has to place the capsule in a position that makes the door facing the customer when the capsule arrives to the kiosk 100.

Employee's control panel 904, not shown on this figure, allows the employee to send, to receive, to close and to open the kiosk door remotely, to speak to the customer, to prioritize orders shown on the screen 901, and to assign the number of the kiosk the order should be send to.

A large window 1504 allows the employee to remove the capsule from the tube, load it again with the next order and resend it again to its new destination.

This version of the TCS is probably not suitable for food industry, however it is very suitable for other businesses such as Barnes and Nobel, Best Buy.

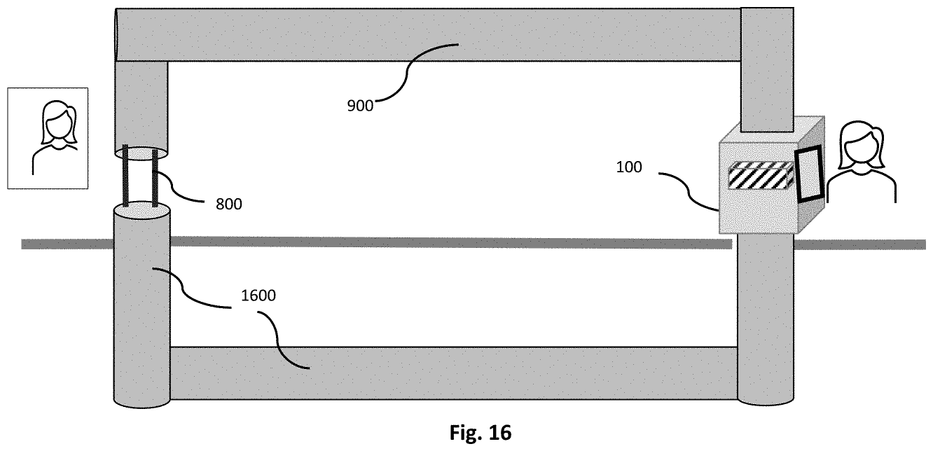

FIG. 16 illustrate the other options of constructing the above described TCS systems. These same TCS can be configurated to be totally underground 1600 or can be configurated to be above the ground in part and below the ground in part as shown in the illustration.

Although the description above contains many specifies, these should not be constructed as limiting the scope of the invention but as merely providing illustration of some of the presently preferred embodiments of this invention.

What is claimed is:

1. A system for online order and easy pickup comprising:
a. a business mobile application/website capable of accepting online order and payment, setting up a time for customer's pickup of the order, generating an order number and a readable code associated with said order number,
b. at least one kiosk located at the business facility for customers' order pickup, and capable of reading said order number and its associated code and to automatically unlock its door in response to said reading, wherein said kiosk's door can be unlocked remotely by a business employee,
c. a freely mobile capsule carrying an order configurated for travel through a tube conveyor system between said business processing station and said kiosk,
d. a tube conveyor system (TCS) connects the business processing station with said kiosk and having a track internally for the travel of said capsule,
e. A mover to said capsule comprising at least one movable electromagnet (EM) connected to a motorized cable driving said EM from one end to another, wherein said EM is turned on and off in order to pick up, drop, and move said capsule between two destinations.

2. said kiosk in claim 1 incorporates a payment processing component.

3. said capsule in claim 1 comprises freely moving wheels travelling along said tack.

4. Said capsule in claim 1 comprises two compartments, where in one of its compartments contains heating element and rechargeable battery.

5. said TCS in claim 1 can be placed totally above the ground, totally under the ground, or above the ground in part and below the ground in part.

6. A system for online order and easy pickup comprising:
a. a business mobile application/website capable of accepting online order and payment, setting up a time for customer's pickup of the order, generating an order number and a readable code associated with said order number,
b. at least one kiosk located at the business facility for customers' order pickup, and capable of reading said order number and its associated code and to automatically unlock its door in response to said reading, wherein said kiosk's door can be unlocked remotely by a business employee,
c. a freely mobile capsule carrying an order configurated for travel through a tube conveyor system between said business processing station and said kiosk,
d. a tube conveyor system (TCS) connects the business processing station with said kiosk and having a track internally for the travel of said capsule,
e. a mover to said capsule comprising a motorized cable moving said capsule along said track inside said TCS between sending station and a receiving kiosk.

7. said kiosk in claim 6 incorporates a payment processing component.

8. said capsule in claim 6 comprises freely moving wheels travelling along said tack.

9. Said capsule in claim 6 comprises two compartments, where in one of its compartments contains heating element and rechargeable battery.

10. said TCS in claim 6 can be placed totally above the ground, totally under the ground, or above the ground in part and below the ground in part.

11. A system for online order and easy pickup comprising:
a. a business mobile application/website capable of accepting online order and payment, setting up a time for customer's pickup of the order, generating an order number and a readable code associated with said order number,
b. at least one kiosk located at the business facility for customers' order pickup, and capable of reading said order number and its associated code and to automatically unlock its door in response to said reading, wherein said kiosk's door can be unlocked remotely by a business employee,
c. a freely mobile capsule carrying an order configurated for travel through a tube conveyor system between said business processing station and said kiosk,
d. a tube conveyor system (TCS) connects the business processing station with said kiosk and having a track internally for the travel of said capsule,
e. A mover to said capsule comprising at least two stationary electromagnets (EMs) to move said capsule from the processing station to the kiosk and two other EMs to move the capsule back from the kiosk to the business processing station.

12. said kiosk in claim 11 incorporates a payment processing component.

13. said capsule in claim 11 comprises freely moving wheels travelling along said tack.

14. Said capsule in claim 11 comprises two compartments, where in one of its compartments contains heating element and rechargeable battery.

15. said TCS in claim 11 can be placed totally above the ground, totally under the ground, or above the ground in part and below the ground in part.

16. A system for online order and easy pickup comprising:
a. a business mobile application/website capable of accepting online order and payment, setting up a time for customer's pickup of the order, generating an order number and a readable code associated with said order number,
b. at least one kiosk located at the business facility for customers' order pickup, and capable of reading said order number and its associated code and to automatically unlock its door in response to said reading, wherein said kiosk's door can be unlocked remotely by a business employee,
c. a freely mobile capsule carrying the order configurated for travel through a tube conveyor system between said business processing station and said kiosk
d. a tube conveyor system (TCS) connects the business processing station with said kiosk and having a track internally for the travel of said capsule.
e. A mover to said capsule using pneumatic energy comprising air compressor, a Filter-regulator-Lubricator (FRL) component, and a directional control valve

17. Said capsule in claim 16 comprises two compartments, where in one of its compartments contains heating element and rechargeable battery.

18. said TCS in claim 16 can be placed totally above the ground, totally under the ground, or above the ground in part and below the ground in part.

19. A system for on-spot easy order and easy pickup comprising:
a. at least one kiosk located at the business facility for customers to place an order, pay for the order, and pick-up the order at said kiosk, wherein said kiosk comprises a payment processing component,
b. a freely mobile capsule carrying the order configurated for travel through a tube conveyor system between said business processing station and said kiosk,
c. a tube conveyor system (TCS) connects the business processing station with said kiosk and having a track internally for the travel of said capsule,
d. a mover to said capsule between the sender and the receiver using mechanical, electromagnet or pneumatic energy system.

20. said TCS in claim 19 can be placed totally above the ground, totally under the ground, or above the ground in part and below the ground in part.
